(19) United States
(12) Patent Application Publication
(10) Pub. No.: US 2010/0035173 A1
(43) Pub. Date: Feb. 11, 2010

(54) AQUEOUS SULFONATE-FUNCTIONAL POLYMER DISPERSIONS, METHODS OF MAKING THE SAME AND TONER PARTICLES FORMED THEREFROM

(76) Inventor: Alan Toman, Apex, NC (US)

Correspondence Address: MYERS BIGEL SIBLEY & SAJOVEC, PO BOX 37428, RALEIGH, NC, 27627, US

(21) Appl. No.: 12/189,523

(22) Filed: Aug. 11, 2008

(51) Int. Cl. G03G 9/087; C08J 3/00

(52) U.S. Cl. 430/109.4; 525/418; 525/390

(57) ABSTRACT

Provided herein are polymer dispersions that include a polymer having a sulfonate group bound to an aliphatic portion thereof. Such polymer dispersions can be stably formed without the use of other internal surfactants or the use of external surfactants. Also provided are methods of making the same and toner particles formed from the same.

### FIELD OF THE INVENTION

The present invention relates to water dispersible polymers. More particularly, the present invention relates to water dispersible polymers that may be useful in toner applications.

### BACKGROUND OF THE INVENTION

In typical dry-type electrophotographic processes, latent electrostatic images formed on a photoconductor are developed by means of a triboelectrically charged toner. Specifically, when an image is formed by a photographic copying machine, a surface of a roller composed of a photoconductive and photosensitive material is charged. An electrostatic latent image is formed by exposure to the light reflected from the surface of an original to be copied. The latent image is developed by a toner, with the formed visible image being transferred to a paper or the like. The transferred image is fixed on the paper by compression under heating, and thus a copy print is obtained.

A typical toner includes several components including a toner resin, a colorant and an electrostatic carrier material. Traditionally, toner resins have been made by compounding and melting the toner components (resin, colorant, etc.), followed by extruding the mixture into strands or pellets. These solid masses are then pulverized into small particles and sorted to provide the desired particle size and particle size distribution. While this method has been widely used, it has several limitations. For example, forming toner particles having a size less than about 8 micron is not economically feasible using these conventional techniques. In addition, the shape of the toner particles may be undesirably non-uniform, which may affect toner properties, such as charge-to-mass ratio. Furthermore, narrow particle size distributions may be difficult to achieve. Other problems include the energy intensive pulverizing process and the inability to tailor the microstructure of the toner particles.

The disadvantages associated with conventional methods of producing toner have led to the so-called “chemically-produced toner” or CPT. As opposed to the “large-to-small” approach of conventional toner processes, CPT processes use a “small-to-large” approach, using polymerization techniques to form the basic toner particle structure. While there are many different types of CPT, typical polymerization techniques include suspension polymerization, emulsion polymerization and aggregation, microencapsulation, dispersion and condensation polymerization. These techniques can produce toner particles in a 3 to 5 micron size or less range, and may produce narrower particle size distributions than typically obtained from conventional processes. In addition, relatively uniform toner particle shape may be achieved and particle composition may be more precisely controlled.

One disadvantage with current methods for producing CPT is that they require an emulsifier/surfactant. This may be problematic because a small amount of residual surfactant may undesirably affect the properties of the toner particles, including the tribocharge, and the removal of all of the surfactant from the particles may be difficult to achieve.

Therefore, it would be desirable to obtain CPT that is not synthesized using a surfactant. Such toner resins should ideally have desirable pigment dispersion, heat resistance and chargeability, as well as relatively low fusing temperatures. Furthermore, the toner resins should ideally be relatively inexpensive to produce.

### SUMMARY OF THE INVENTION

Provided according to some embodiments of the invention are polymer dispersions that include a polymer having an internal surfactant bound to an aliphatic portion thereof. The internal surfactant is a sulfonate group, and no other internal or external surfactants are present in the polymer.

In some embodiments, the polymer includes a polyester, such as a polyester that includes etherified bisphenol A. In some embodiments, the polymer has a glass transition temperature in a range of 45 to 90° C. Furthermore, in some embodiments, the polymer has a T_{1/2} value in a range of 100 to 180° C., in some embodiments, has an acid value in a range of 0 to 50, and in some embodiments, has a number average molecular weight in a range of 1000 to 20,000.

According to some embodiments of the invention, the polymer dispersions have a non-volatile content in a range of 10 to 60 weight percent.

Also provided according to some embodiments of the invention are toner particles that are formed from a polymer dispersion of the invention. Such toner particles may also include at least one additive such as a paraffin, rheology modifying agent, inhibitor, lubricant, colorant, charge control agent, carrier material and/or a shrink-reducing additive. Such toner particles may have a T_{g} in a range of 40 to 90° C., a T_{1/2} in a range of 90 to 160° C. and a charge per mass of in a range of −50 to 50 μc/g.

Furthermore, provided according to embodiments of the inventions are methods of forming the sulfonate-functional polymer dispersions of the invention. Such methods may include dissolving a polymer, which (a) includes aliphatic unsaturation and (b) does not include an internal surfactant group, in a solvent that comprises an organic solvent; reacting a sulfonation reagent with the aliphatic unsaturation of the polymer to form a sulfonate-functional polymer; and removing a portion of the organic solvent, to form the sulfonate-functional polymer dispersion. Such dispersions are free of external surfactant. Such methods may further include the step of adding water to the solvent after forming a sulfonate-functional polymer, but prior to removing the portion of the organic solvent. In particular embodiments, the sulfonation reagent includes at least one of sodium hydrogen sulfide, sodium bisulfite and sodium metabisulfite. Additionally, in particular embodiments, the organic solvent is isopropanol.

### DETAILED DESCRIPTION OF EMBODIMENTS OF THE INVENTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Provided herein are polymer dispersions that include a polymer having a sulfonate functional group bound to an aliphatic portion thereof. The sulfonate functional group of the polymer in the polymer dispersion may act as an internal surfactant, and in some embodiments, such polymer dispersions are stable without the use of other internal surfactants and/or the use of external surfactants.

As used herein, the term “polymer dispersion” refers to a polymeric composition that is dispersed in an aqueous solvent. Therefore, the term polymer dispersion encompasses polymer emulsions, suspensions and dispersions, and the like. While the dispersions described herein are aqueous, in some embodiments, small quantities of organic solvents may be present in the polymer dispersion. In particular embodiments, the polymer dispersions may include up to 50 weight percent of an organic solvent. Suitable organic solvents include oxygenated solvents with some degree of water solubility. Examples include, but are not limited to, isopropanol, butanol, propanol, ether-alcohols, ketones, and mixtures thereof. In some embodiments of the invention, the dispersions have a non-volatile content in a range of 10 and 50 weight percent.

The term “sulfonate functional group” or “sulfonate,” as used herein, refers to both the free sulfonate anion (—S(═O)₂O—) and salts thereof Therefore, the term sulfonate encompasses sulfonate salts such as sodium, lithium, potassium and ammonium sulfonate.

The term “surfactant” refers to a functional group or a molecule that can act to markedly reduce the interfacial surface tension between the polymer and the aqueous solvent, and includes cationic, anionic, amphiphilic and non-ionic surfactants. An “internal surfactant” is a functional group linked to the polymer that acts as a surfactant. In all embodiments of the present invention, the internal surfactant is a sulfonate functional group. Other internal surfactants, such as polyols, phosphates and quaternary amines, are not present in the polymer dispersions. The term “external surfactant” refers to a molecule that acts as a surfactant and is not bound to the polymer. The polymer dispersions of the invention do not include any external surfactants.

Any suitable polymer having a having a sulfonate group bound to an aliphatic portion thereof may be used in polymer dispersions according to embodiments of the invention. Polymers having sulfonate groups attached to an aliphatic portion thereof may be less expensive and easier to produce than polymers that are formed from sulfonated aromatic monomers.

In some embodiments of the invention, the sulfonate functional polymer of the polymer dispersion may include a polyester. In some embodiments, such a polyester is formed by the reaction of a unsaturated aliphatic polycarboxylic acid and an aliphatic diol. As used herein, the term “unsaturated aliphatic polycarboxylic acid” is meant to refer to a non-aromatic molecule with one or more alkene or alkyne bonds and further including two or more carboxylic acids. Any suitable unsaturated aliphatic polycarboxylic acid may be used, but exemplary aliphatic polycarboxylic acids include fumaric acid, maleic acid and hydride, citraconic acid, itaconic acid, glutaconic acid, and the like. As used herein, the term “aliphatic diol” is meant to refer to a non-aromatic molecule with two hydroxy functional groups. Any suitable aliphatic diol may be used, but exemplary aliphatic diols include ethylene glycol, propylene glycol, diethylene glycol, neopentyl glycol, 1,4-cyclohexanedimethanol, 1,3-propanediol, 1,4-butanediol, 1,5-pentanediol, 1,6-hexanediol, 1,8-octanediol, 2,2,4-trimethyl-1,3-pentanediol, 2,2,4,4-tetramethyl-1,3-cyclobutanediol, and the like.

In some embodiments of the invention, aromatic polycarboxylic acids and/or aromatic diols may be used. For example, in some embodiments, a bisphenol A, such as an etherified bisphenol A may be included in the polyester. Other bisphenol resins, such as 4,4′-dihydroxydiphenylsulfone, 4,4-dihydroxy biphenyl, 4,4′-dihydroxydiphenymethane, 2,2′-dihydroxydiphenyloxide, and the like, may also be used in some embodiments. Other bisphenyl-type epoxy resins which may be used are glycidyl ethers and β-methyl glycidyl ethers of bis(4-hydroxyphenyl)methane (Bisphenol F); 1,1-bis(4-hydroxyphenyl)ethane (Bisphenol AD), and the like. Mixtures of any of the above may also be used.

In some embodiments of the invention, other components may be included in the polyester. For example, a glycidyl ester of an alkanoic acid, a branching agent and/or an epoxy may also be included in the polyester. As used herein, the term “glycidyl ester of an alkanoic acid” is meant to refer to an alkanoic acid, such as straight or branched hexanoic acid, heptanoic acid, octanoic acid, nonanoic acid, decanoic acid, undecanoic acid, dodecanoic acid, and the like, that is esterified by a group that includes a glycidyl functionality. An exemplary glycidyl ester of an alkanoic acid is a glycidyl ester of neodecanoic acid, such as Glydexx N-10®. As used herein, the term “branching agent” is meant to refer to a multifunctional carboxylic acid (or its corresponding anhydride) or a polyol that is added to a polymer to provide branched polyesters. Suitable branching agents include trimellitic acid, trimellitic anhydride, pyromellitic dianhydride, trimethylolpropane, glycerol, pentaerythritol, citric acid, tartaric acid, 3-hydroxyglutaric acid, and the like. As used herein, the term “epoxy” is meant to refer to a monomer or polymer that includes epoxy functional groups. Exemplary epoxies include, glycidyl methacrylate/acrylic acid copolymers, glycidyl methacrylate/styrene copolymer and Novalac epoxies. The term epoxy does not include epoxies that include Bisphenol A.

The polyesters described herein have been identified by referring to the monomers/molecules that are reacted to form the polyester. Thus, as one of skill in the art understands, the final polyester may include only the resulting crosslinked or non-crosslinked polymer formed from the reaction of the components and may not include any of the starting molecules/monomers. However, in some embodiments, unreacted monomer may still be present in the composition. Polyester resins that may be used in embodiments of the invention include Fine-Tone®, Fine-Clad® and Aroplaz® resins, available from Reichhold, Inc.

In some embodiments, only a sulfonate functional polymer according to an embodiment of the invention is present in the dispersion. However, in some embodiments, one or more additional polymers may be present in the polymer dispersion, such that polymer dispersions may include mixtures of two or more different types of polymers. In the latter case, none of the one or more additional polymers in the polymer dispersion includes an internal surfactant, or is itself an external surfactant.

As described above, in some embodiments, the polymer dispersions may be useful in toner applications. For example, the polymer dispersions may be dried to form toner particles. Solid particles may also be obtained by conventional spray drying, precipitation or evaporation techniques. Thus, according to some embodiments of the invention, provided are toner particles that are formed from a polymer dispersion according to an embodiment of the invention. The toner particles may also include other additives known to skilled artisans, including, but not limited to, paraffins, rheology modifying agents, inhibitors, lubricants, colorants, charge control agents, carrier materials, and shrink-reducing additives. Any of the various suitable percentages of these additives can be used in conjunction in the toner particles. In some embodiments, the average particle size is less than approximately 350 nm.

Particular properties of the sulfonate functional polymer may be important in evaluating its suitability for use in toner applications. For example, properties such as glass transition temperature (T_{g}), T_{1/2}, acid value and molecular weight may be assessed. These parameters are well-known to those of ordinary skill in the art and so need not be defined herein. However, as used herein, the T_{g} values and ranges are those obtained via differential scanning calorimetry (DSC), the T_{1/2} values and ranges are those obtained via a capillary flow rheometer, the acid values and ranges are those measured in accordance with ASTM D 1639, and the molecular weight is the number average molecular weight as determined via gel permeation chromatography using a polystyrene standard.

In some embodiments, the sulfonate-functional polymer used to form the toner particle may have a T_{g} in a range of 45 to 90° C. In some embodiments, the sulfonate-functional polymer may have a T_{1/2} value in a range of 100 to 180° C. Additionally, in some embodiments, the sulfonate-functional polymer may have an acid value in a range of 0 to 50. Furthermore, in some embodiments, the sulfonate-functional polymer may have a number average molecular weight in the range of 1000 to 20,000.

According to some embodiments of the invention, toner particles that include the sulfonate-functional polymer have a T_{g} in a range of 40 to 90° C., a T_{1/2} in a range of 90 to 160° C. and a charge per mass in a range of −50 to 50 μc/g. The “charge per mass” is measured by a charge-to-mass analyzer using either the draw-off or blow-off method.

Also provided according to some embodiments of the invention are methods of forming sulfonate-functional polymer dispersions. In some embodiments, methods of forming sulfonate-functional polymer dispersions include dissolving a polymer that (a) has aliphatic unsaturation and (b) does not include an internal surfactant group, in a solvent that includes an organic solvent; reacting a sulfonation reagent with the aliphatic unsaturation of the polymer to form a sulfonate-functional polymer; and removing a portion of the organic solvent, to form the sulfonate-functional polymer dispersion. In addition, such dispersions are free of external surfactant. Any of the polymer dispersions described herein may be formed according to such methods.

The term “aliphatic unsaturation” refers to a non-aromatic portion of a polymer that includes unsaturation, e.g., an alkenylene (—CH═CH—) or alkynylene (—C≡C—) group.

The term “sulfonation reagent,” as used herein, refers to any reagent that can be reacted with the aliphatic unsaturation on the polymer to covalently attach a sulfonate group thereto. Any suitable sulfonation reagent may be used. However, in some embodiments, the sulfonation reagent includes at least one of sodium hydrogen sulfide, sodium bisulfite and sodium metabisulfite.

In some embodiments, methods further include the step of adding water to the solvent after forming a sulfonate-functional polymer, but prior to removing the portion of the organic solvent.

Any suitable organic solvent may be used in methods according to embodiments of the invention. However, in particular embodiments, the organic solvent includes an oxygenated solvent having at least partial water solubility, such as isopropanol, butanol, propanol, and mixtures thereof.

The present invention will now be described in more detail with reference to the following examples. However, these examples are given for the purpose of illustration and are not to be construed as limiting the scope of the invention.

### EXAMPLES

### Example 1

59.5 grams of an etherified bisphenol A containing polymer (Fine-Tone T-382ES from Reichhold, Inc.) was dissolved in 133.4 grams of isopropanol. The mixture was heated to 80° C. and 7.2 grams of sodium hydrogen sulfide dissolved in 33.4 grams of deionized water was added over 15 minutes. After four hours, 33.4 grams of deionized water was then added. After an additional 3.5 hours, 200.1 grams of deionized water were added. The dispersion was heated to 90° C. and the solvent was removed. The final dispersion had an acid value of 0.6 and a non-volatile content of 22.4%. A dried sample of the dispersion had a glass transition temperature of 72° C. and a T_{1/2} value of 153° C., as measured by a Shimadzu CFT-500D capillary flow rheometer.

### Example 2

100 grams of an etherified bisphenol A containing polyester (Fine-Tone T-382ES from Reichhold, Inc.) was dissolved in 200 grams of isopropanol. The solution was heated to 83° C., and 3.9 grams of sodium bisulfite dissolved in 50 grams of deionized water was added over 30 minutes. After one hour, 50 grams of deionized water was added over 30 minutes. After one hour, 50 grams of deionized water were added and the solution was heated to 93° C. to remove the solvent. During the stripping stage, 35 grams of deionized water was added. The final dispersion had a non-volatile content of 48.1%, a viscosity of 268 cps and a mean volume particle size of 104 nm. A dried sample of the dispersion had a glass transition temperature of 61° C. and a T_{1/2} value of 119° C.

### Example 3

A polyester was made by the reaction of 404.1 grams of propoxylated bisphenol A and 87.8 grams of fumaric acid. This polyester had a glass transition temperature of 30 ° C., an acid value of 8.2, a melt viscosity of 13.5 P, measured at 125° C. with a Brookfield CAP 2000 viscometer, and a T_{1/2} value of 65° C. 100 grams of this polyester was dissolved in 100 grams of isopropanol and heated to 79° C. 3.87 grams of sodium metabisulfite, dissolved in 25 grams of deionized water, was added. After one hour 25 grams of deionized water was added. After an additional one hour and 25 minutes, 25 grams of deionized water was added and the solution was heated to 90° C. to remove solvent. During the solvent removal, 100 grams of deionized water was added. The final dispersion has a non-volatile content of 35.2%, a viscosity of 110 cps and a mean volume particle size of 20 nm. A dried sample of the dispersion had a glass transition temperature of 39° C. and a T_{1/2} value of 76° C.

### Example 4

A polyester was made by the reaction of 475.9 grams of propoxylated bisphenol A and 124.1 grams of fumaric acid. This polyester had a glass transition temperature of 45° C., an acid value of 2.8, a melt viscosity of 23.9 P, measured at 150° C. with a Brookfield CAP 2000 viscometer, and a T_{1/2} value of 83° C. 100 grams of this polyester was dissolved in 200 grams of isopropanol and heated to 83° C. 3.97 grams of sodium bisulfite, dissolved in 50 grams of deionized water, was added over 10 minutes. The solution was then heated to 93° C. to remove solvent. During the solvent removal, 100 grams of deionized water was added. The final dispersion had a non-volatile content of 42.7%, a viscosity of 1360 cps and a mean volume particle size of 161 nm. A dried sample of the dispersion had a glass transition temperature of 49° C. and a T_{1/2} value of 101° C.

### Example 5

A polyester was synthesized in the accordance with the procedure described in Example 4. 100 grams of this polyester was dissolved in 200 grams of isopropanol and heated to 83° C. 7.74 grams of sodium bisulfite, dissolved in 25 grams of deionized water, was added. After 20 minutes, 25 grams of deionized water was added. After an additional 30 minutes, 25 grams of deionized water was added. After 30 additional minutes, 25 grams of deionized water was added and the solution was heated to 90° C. to remove the solvent. During solvent removal, 95 grams of deionized water was added. The final dispersion had a non-volatile content of 38.3%, a viscosity of 38600 cps and a mean volume particle size of 50 nm. A dried sample of the dispersion had a glass transition temperature of 51° C. and a T_{1/2} value of 121° C.

1. A polymer dispersion comprising
a polymer having an internal surfactant bound to an aliphatic portion thereof,
wherein the polymer dispersion is free of an external surfactant, and
wherein the internal surfactant consists of a sulfonate group.

2. The polymer dispersion of claim 1, wherein the polymer comprises a polyester.

3. The polymer dispersion of claim 2, wherein the polyester comprises etherified bisphenol A.

4. The polymer dispersion of claim 2, wherein the polymer has a glass transition temperature in a range of 45 to 90° C.

5. The polymer dispersion of claim 2, wherein the polymer has a T_{1/2} value in a range of 100 to 180° C.

6. The polymer dispersion of claim 1, wherein the polymer has an acid value in a range of 0 to 50.

7. The polymer dispersion of claim 1, wherein the polymer has a number average molecular weight in a range of 1000 to 20,000.

8. The polymer dispersion of claim 1, having a non-volatile content in a range of 10 to 60 weight percent.

9. A toner particle formed from the polymer dispersion of claim 1.

10. The toner particle of claim 9, wherein the polymer comprises a polyester.

11. The toner particle of claim 10, further comprising at least one additive selected from the group consisting of a paraffin, rheology modifying agent, inhibitor, lubricant, colorant, charge control agent, carrier material and shrink-reducing additives.

12. The toner particle of claim 10, wherein the toner particle has a T_{g} in a range of 40 to 90° C., a T_{1/2} in a range of 90 to 160° C. and a charge per mass of in a range of −50 to 50 μc/g.

13. A method of forming a sulfonate-functional polymer dispersion, comprising
dissolving a polymer, which (a) comprises aliphatic unsaturation and (b) does not comprise an internal surfactant group, in a solvent that comprises an organic solvent;
reacting a sulfonation reagent with the aliphatic unsaturation of the polymer to form a sulfonate-functional polymer; and
removing a portion of the organic solvent, to form the sulfonate-functional polymer dispersion,
wherein the polymer dispersion is free of external surfactant.

14. The method of claim 13, further comprising the step of adding water to the solvent after forming a sulfonate-functional polymer, but prior to removing the portion of the organic solvent.

15. The method of claim 13, wherein the sulfonation reagent comprises at least one of sodium hydrogen sulfide, sodium bisulfite and sodium metabisulfite.

16. The method of claim 13, wherein the organic solvent is isopropanol.

17. The method of claim 13, wherein the polymer comprises a polyester.

18. The method of claim 17, wherein the polyester comprises etherified bisphenol A.

19. The method of claim 18, wherein the sulfonate-functional polymer has an acid value in a range of 0 to 50.

20. The method of claim 19, wherein the sulfonate-functional polymer has a T_{1/2} value in a range of 100 to 180° C.

21. The method of claim 20, wherein the sulfonate-functional polymer has a number average molecular weight in a range of 1000 to 20,000.
